(19) United States
(12) Patent Application Publication
(10) Pub. No.: US 2015/0308044 A1
(43) Pub. Date: Oct. 29, 2015

(54) Press jacket for press roller

(71) Applicant: VOITH PATENT GMBH, Heidenheim (DE)

(72) Inventors: DELPHINE DELMAS, HEIDENHEIM (DE); UWE MATUSCHCZYK, GEISLINGEN (DE); HERMANN REICHERT, HEIDENHEIM (DE); MICHAEL WOKUREK, WIEN (AT)

(73) Assignee: VOITH PATENT GMBH, HEIDENHEIM (DE)

(21) Appl. No.: 14/650,361

(22) PCT Filed: Nov. 28, 2013
(86) PCT No.: PCT/EP2013/074935

§ 371 Date: Jun. 8, 2015

(30) Foreign Application Priority Data
Dec. 7, 2012 (DE) 10 2012 222 546.3
Feb. 11, 2013 (DE) 10 2013 202 941.1
Nov. 6, 2013 (DE) 10 2013 222 458.3

(51) Int. Cl. D21F 3/02; C08L 75/06; C08L 75/04; C08L 75/08

(52) U.S. Cl. CPC D21F 3/02; C08L 75/08; C08L 75/06; C08L 75/04

(57) ABSTRACT

A press jacket for a press roller, in particular for a press roller of a shoe press for dewatering a fibrous material web, in particular a paper, cardboard, tissue or pulp web, or a transport band, in particular for a machine for producing or treating a fibrous material web, in particular a paper, cardboard or tissue machine, includes at least one layer containing polyurethane which contains a polyurethane matrix with a mixture of at least two prepolymers. Each prepolymer is a reaction product of two different polyols with a polyisocyanate.

The invention relates to a press jacket for a press roller of a shoe press for dewatering a fibrous material web, in particular a paper, cardboard, tissue or pulp web, in a machine for producing the same, according to the preamble of claim 1, 4 or 7.

In such a shoe press, the material web passes together with at least one water-impermeable press band, for example a press felt, through a nip which is formed by a press roller and a counter-roller. The press roller consists of a revolving press jacket and a stationary press element, the shoe, which abuts a bearing yoke and which is pressed against the revolving press jacket by means of hydraulic press elements. The press jacket is thereby pressed against the counter-roller in the nip. The fibrous material web can also pass through the nip of the shoe press between two press felts or between a press felt and a water-impermeable transfer band.

As the fibrous material web passes through the nip, water is pressed out of the material web. Shoe presses are distinguished by the fact that the shoe can be adapted to the counter-roller by a concave shape, and a longer press zone is thereby produced. The length of the nip is preferably more than 250 mm in the direction of travel of the web. Significantly more water is therefore pressed out with shoe presses than with normal roller presses. The water pressed out in the nip, or at least the portion thereof that is pressed out in the direction of the press roller, must be stored temporarily in the press felt and in the press jacket during passage through the nip. After leaving the nip, the water is discharged from the press jacket into troughs or is removed from the felt by means of suction elements, before entry into the nip again. In order to have the necessary storage volume for the water during passage through the nip, press jackets are in many cases provided with grooves or blind holes on the lateral surface facing the fibrous material web.

The press jacket must be sufficiently flexible that it can be guided round the shoe, it must be sufficiently rigid that it is not deformed or compressed too greatly in the nip under the press load, and it must be sufficiently wear-resistant. Press jackets are therefore made of a single- or multi-ply polymer layer, preferably of polyurethane, in which reinforcing threads in the form of non-crimped fabrics or woven fabrics are embedded.

Such a press jacket is already known from EP 1 087 056 A2. Disclosed therein is a press jacket which is provided on the lateral surface with blind holes for receiving the water that has been pressed out.

EP 2 248 944 A1 describes a press jacket for a shoe press which is composed of a ply of crosslinked polyurethane in which woven fabric is embedded. The crosslinked polyurethane is the reaction product of a prepolymer, which has been prepared from an isocyanate component comprising from 55 to 100 mol. % p-phenylene diisocyanate, 4,4′-methylenediphenyl diisocyanate or toluylene diisocyanate, and a polyol component comprising polypropylene glycol, polytetramethylene glycol or polycarbonate diol, and a crosslinker component, which comprises from 75 to 99.9 mol. % of an aliphatic diol compound having a molecular weight of from 62 to 1000, hydroquinone bis-β-hydroxylethyl ether or an organic polyamine compound having a molecular weight of from 108 to 1300 and from 25 to 0.1 mol. % of an aliphatic triol compound having a molecular weight of from 92 to 134. This publication additionally discloses a corresponding press jacket, for the production of which there is used a crosslinker component which comprises from 60 to 99.8 mol. % of an aliphatic diol compound having a molecular weight of from 62 to 1000 or hydroquinone bis-β-hydroxylethyl ether, from 0.1 to 15 mol. % of an organic polyamine compound having a molecular weight of from 108 to 1300, and from 25 to 0.1 mol. % of an aliphatic triol compound having a molecular weight of from 92 to 134.

Although the above press jackets have sufficient flexibility and at the same time sufficient rigidity, their resistance to chemicals, in particular to water and oil, their wear resistance, their resistance to crack formation, their crack growth resistance and their swelling behavior are in need of improvement.

Accordingly, it is an object of the invention, by using a mixture of prepolymers, purposively to achieve specific properties such as a lower swelling behavior and at the same time maintain good dynamic properties.

The object is achieved by the characterizing features of claim 1, 4 or 7 in each case in conjunction with the generic features.

It is provided according to the invention that the at least one layer comprises a polyurethane matrix of at least two prepolymers and at least one crosslinker, wherein each prepolymer is a reaction product with a different polyol.

According to a further aspect of the invention it can also be provided that the at least one layer comprises a polyurethane matrix having a prepolymer and having at least one crosslinker which is a reaction product of a polyisocyanate with a mixture of at least two different polyols.

According to a third aspect of the invention it can be provided that the at least one layer comprises a polyurethane matrix having a prepolymer, which prepolymer comprises an MDI polyether polycarbonate polyol, a TDI polyether polycarbonate polyol, a PPDI polyether polycarbonate polyol, an NDI polyether polycarbonate polyol, a DBDI polyether polycarbonate polyol, a TODI polyether polycarbonate polyol or a mixture of two or more of the above polyols, wherein each of the polyols comprises both ether groups and carbonate groups.

The polyurethanes so prepared are distinguished by high wear resistance, a low tendency to crack formation and crack growth, low sensitivity to water, oil, acids, lyes, solvents, and a low tendency to swelling in the above-mentioned substances.

Further advantageous aspects of the invention will become apparent from the dependent claims.

Preferably, the mixing ratio of the at least two prepolymers or of the at least two polyols can be from 90/10 to 10/90, preferably 50/50. The latter mixing ratio in particular is especially advantageous in respect of the processability through the rate of reaction, the viscosity as well as the swelling and the dynamic properties. Most especially, the mentioned mixing ratio is to be regarded as being advantageous in respect of the viscosity.

According to an advantageous aspect of the invention, the prepolymers can be a reaction product of 4,4′-diphenylmethane diisocyanate (MDI), toluene 2,4-diisocyanate (TDI), 3,3′-dimethyl-4,4′-biphenylene diisocyanate (TODD, 1,4-phenylene diisocyanate (PPDI), naphthylene 1,5-diisocyanate (NDI) or 4,4-dibenzyl diisocyanate (DBDI) with the respective polyol, or of 4,4′-diphenylmethane diisocyanate (MDI), toluene 2,4-diisocyanate (TDI), 3,3′-dimethyl-4,4′-biphenylene diisocyanate (TODD, 1,4-phenylene diisocyanate (PPDI), naphthylene 1,5-diisocyanate (NDI) or 4,4-dibenzyl diisocyanate (DBDI) with the mixture of polyols. MDI is the most inexpensive isocyanate, PPDI is distinguished by very good dynamic properties and hydrolytic stability, NDI has very good heat and water resistance, DBDI has a high modulus, and TODI likewise has very good heat resistance and hydrolytic stability and has only slight fatigue tendencies.

The polyols can preferably be selected from: polyester polyol (e.g. polycaprolactone polyol), polyether polyol (e.g. polytetramethylene ether glycol (PTMEG)), polypropylene glycol (PPG), polyethylene glycol (PEG) or polyhexamethylene ether glycol, polycarbonate polyol, polyether carbonate polyol, polybutadiene polyol, perfluoropolyether polyol, silicone polyol (e.g. silicone diol). The mentioned polyols are available commercially and can be mixed and processed as required.

The molecular weight of the polyols is preferably from 1000 to 3000 g/mol.

The crosslinker can preferably be selected from ethylene glycol, diethylene glycol, propylene glycol, di polypropylene glycol, polypropylene glycol, polybutylene glycol, 1,4-butanediol, 1,3-propanediol, 1,5-pentanediol, 1,6-hexanediol, polyethylene glycol, dihydroxymethylpropionic acid (DHPA), hydroquinone bis(2-hydroxyethyl) ether (HQEE), hydroxyphenyl ether resorcinol (HER), trimethylolpropane (TMP), hydrazine, ethylenediamine, diethylenetoluenediamine (DEDTA), diethylmethylbenzenediamine (DETDA), methylene-bis-orthochloroaniline (MOCA), dimethylthiotoluenediamine (DMTDA), trimethylene glycol di(p-aminobenzoate) (TMAB), 4,4′-methylene-bis-(3-chloro-2,6-diethylaniline) (MCDEA), 4,4′-methylene-bis-(2,6-diethylaniline) (MDEA), triisopropanolamine (TIPA), bis-(4-aminocyclohexyl)-methane (PACM). The crosslinker can further consist in part of the polyols or comprise one or more of the polyols that are used for the preparation of the prepolymer.

According to an advantageous embodiment of the invention, the press jacket can be composed of a plurality of layers, wherein at least the outermost layer comprises a prepolymer mixture as claimed in claim 1 and/or as claimed in claim 4 and/or as claimed in claim 7. This is an advantage because the chemical, mechanical and dynamic properties of the press jacket can thereby be adjusted separately from one another.

According to a further advantageous aspect of the invention, the prepolymer mixture as claimed in claim 1 and/or as claimed in claim 4 and/or as claimed in claim 7 can be provided only in regions, preferably in the edge regions of the outermost layer. The highly stressed edge regions, in which the paper web edges run, are thereby outstandingly protected against wear.

The invention will be explained in greater detail below with reference to a preferred embodiment.

Press jackets for shoe press rollers are conventionally composed of a polyurethane material. A reinforcement in the form of yarns is embedded in the polyurethane matrix. The reinforcement can be a non-crimped fabric of threads or a woven fabric. A more detailed description is not necessary at this point, because this is sufficiently well known from the prior art.

The press jacket is conventionally produced by casting the polyurethane. The reinforcement is first wound onto a casting core and then the polyurethane is applied from nozzles which are displaceable in the longitudinal direction of the casting core, while the casting core rotates about its longitudinal axis beneath the nozzles. The polyurethane is thereby applied in a band-like coat, in which the windings are at least adjacent to one another edge to edge.

Application can take place in one or more layers, whereby material variations such as filler gradients in different layers are possible. When the polyurethane has cured, the press jacket is subjected to further processing steps, for example is provided with surface structures, and finally is removed from the casting core.

The above process gives rise to various requirements of the polyurethane mixture. On the one hand, its viscosity upon leaving the nozzle must permit even application; on the other hand, the polyurethane must not be too thin since it otherwise runs and drips off as the casting core is rotated. The so-called pot life, which indicates the crosslinking of the polyurethane over time, should accordingly be so chosen that the polyurethane is solid enough upon application that it does not drip off, but is also reactive enough to be able to enter into a bond with the newly applied polyurethane composition at the next winding.

The press jackets of shoe press rollers are also subject to a large number of chemical and mechanical stresses, as has already been touched upon briefly above. Apart from the wet surroundings, which as well as containing water can also contain inter alia oil-containing substances and further chemicals, the mechanical stresses on the press jacket in particular are significant. As a result of the bending movements in opposite directions as they enter and leave the nip, the press jackets are subject to stresses which in some cases act in opposite directions, in addition to the pressures prevailing in the nip. If the material of the press jacket has been weakened by chemical actions or swelling, cracks will occur, which lead to failure of the press jacket. Consequently, serious damage to the press roller or even to the following sections of the machine can occur if, for example, the polyurethane delaminates and pieces of the press jacket become detached. Especially in relation to occupational safety aspects for the operating personnel, safe operation of the press jacket is of great importance here.

A polyurethane mixture is described hereinbelow which takes account of the above-mentioned requirements and permits the production of a press jacket which, as well as having high mechanical and chemical resistance, also has excellent dynamic properties.

The raw materials for polyurethanes are mainly isocyanates, polyols and polyamines. An isocyanate prepolymer is conventionally used. An isocyanate prepolymer is formed from isocyanate monomers which have been reacted in part with a polyol or with a mixture of polyols. Diisocyanates are of particular importance because they offer the best flexibility and dynamic loading capacity.

The properties of the polyurethane are dependent on many factors: on the type of isocyanate monomer, on the proportion of free monomers, on the XH/NCO ratio, on the type, functionality and molecular weight of the polyols, on the type, functionality and molecular weight of the polyamines, on any fillers, catalysts etc. which may be present.

As polyols for use in press jackets there are employed in particular polyester polyol (e.g. polycaprolactone polyol), polyether polyol (e.g. polytetramethylene ether glycol (PTMEG)), polypropylene glycol (PPG), polyethylene glycol (PEG) or polyhexamethylene ether glycol, polycarbonate polyol, polyether carbonate polyol, polybutadiene polyol, perfluoropolyether polyol, silicone polyol (e.g. silicone diol) etc. The molecular weight of the polyols is preferably from 1000 to 3000 g/mol.

The polyamines and/or polyols used as crosslinkers can be selected from hydrazines, ethylenediamine, diethylenetoluenediamine (DEDTA), diethylmethylbenzenediamine (DETDA), methylene-bis-orthochloroaniline (MOCA), dimethylthiotoluenediamine (DMTDA), trimethylene glycol di(p-aminobenzoate) (TMAB), 4,4′-methylene-bis-(3-chloro-2,6-diethylaniline) (MCDEA), 4,4′-methylene-bis-(2,6-diethylaniline) (MDEA), triisopropanolamine (TIPA), bis-(4-aminocyclohexyl)-methane (PACM); ethylene glycol, diethylene glycol, propylene glycol, dipolypropylene glycol, polypropylene glycol, polybutylene glycol, 1,4-butanediol, 1,3-propanediol, 1,5-pentanediol, 1,6-hexanediol, polyethylene glycol, dihydroxymethylpropionic acid (DHPA), hydroquinone bis(2-hydroxyethyl) ether (HQEE), hydroxyphenyl ether resorcinol (HER), trimethylolpropane (TMP) etc. The crosslinker can further consist in part of the polyols or comprise one or more of the polyols that have been used for the preparation of the prepolymer.

The most important mechanical properties of the polyurethane matrix for a press jacket are wear resistance, low tendency to crack formation and crack growth, low sensitivity to water, oil, acids, lyes, solvents, as well as a low tendency to swelling in the above-mentioned substances.

The positive properties of MDI-, NDI-, TDI-, TODI-, PPDI- and DBDI-based polyurethanes are already known. PTMEG is a conventional polyol which is used for the production of high-performance polyurethane elastomers. The disadvantage of PTMEG is its low thermooxidative stability, which reduces the lifetime of the press jacket.

The dynamic properties of PTMEG-based polyurethanes, on the other hand, tend to be good in comparison with other (polyether) polyols.

Polycarbonate diols (PCDL) are at present relatively expensive and difficult to process because of their high viscosity. Improved or mixed properties are not systematically to be expected when two different polyols are mixed together. By contrast, one can even interfere with the molecular arrangement of the other. Likewise, the hard/soft segment arrangement can be disturbed and lead to a worsening of the properties.

Surprisingly, however, tests have shown that the polyols selected according to the example described in greater detail below have outstanding mixed properties and accordingly are highly suitable for the intended application in the press jackets mentioned at the beginning.

Additional advantages are reduced costs and simple processing, because the viscosity of the mixture remains appropriate.

### PREFERRED EMBODIMENT

A preferred embodiment of the invention is represented by a polyurethane matrix comprising a mixture of from 90/10 to 10/90% by weight of the two prepolymers (MDI-PTMEG)/(MDI-PCDL). A mixture of 50/50% by weight of the two prepolymers (MDI-PTMEG)/(MDI-PCDL) would be particularly preferred. Most particular prominence is to be given to the mentioned mixing ratio in respect of the viscosity.

Laboratory tests have shown that a mixture of 50/50% by weight of the two prepolymers (MDI-PTMEG)/(MDI-PCDL) gives the following property profile: reduced swelling (in water and H₂O₂), good dynamic properties, average viscosity of the prepolymer so that processing is possible. The crosslinker thereby comprises ˜80% molar MCDEA and ˜20% molar polycarbonate diol. The desired hardness is from 90 to 97 ShoreA. The person skilled in the art with the relevant training can determine the correct mixing ratios of prepolymer and crosslinker on the basis of the requirement that the stoichiometry should remain between 0.85 and 1.15.

Problems with the rate of reaction, which can be too high in particular in the case of crosslinking with MCDEA, can effectively be eliminated by the 50/50 mixture. The rate of reaction is lowered.

Swelling by oxidative agents (H₂O₂) is reduced proportionately greatly, in the case of the 50/50 mixture by 60%.

It would also be conceivable first to prepare a mixture of two polyols PTMEG and PCDL and then carry out the reaction with MDI. The prepolymer would then be prepared from MDI/(PTMEG-PCDL).

Furthermore, solutions are conceivable in which the prepolymer consists of an MDI polyether polycarbonate polyol, and the polyol accordingly comprises ether groups and carbonate groups.

The MDI can be replaced wholly or in part by PPDI, TDI, TODI, DBDI or NDI.

It is further conceivable for the press jacket to be composed of a plurality of layers. An outer layer, which comes into contact with the press felt and/or the fibrous material web and accordingly is exposed to water and other chemical substances, can thus be particularly resistant to swelling as a result of the use of the above-mentioned prepolymer mixtures according to the invention, while the inner layers can be composed of different prepolymers. This has the advantage inter alia that the mechanical and chemical properties of the press jacket can be influenced separately from one another.

It is likewise conceivable for the above-mentioned prepolymer mixtures to be used only in specific regions of the jacket, for example at the shoe edge. The stress is particularly high in these regions, on the one hand because the edge of the press shoe acts mechanically on the press jacket, and on the other hand because the edges of the paper web stress the edge regions mechanically by oscillations.

1-12. (canceled)

13. A press jacket for a press roller of a shoe press for dewatering a fibrous paper, cardboard, tissue or pulp material web or a transport band for a machine for producing or treating a fibrous paper, cardboard or tissue material web, the press jacket or the transport band comprising:
at least one layer containing polyurethane, said at least one layer containing a polyurethane matrix with a mixture of at least two prepolymers, each prepolymer being a reaction product of two different polyols with a polyisocyanate.

14. The press jacket according to claim 13, wherein said at least two prepolymers have a mixing ratio of from 95/5 to 5/95.

15. The press jacket according to claim 13, wherein said at least two prepolymers have a mixing ratio of 50/50.

16. The press jacket according to claim 13, wherein said prepolymers are a reaction product of 4,4′-diphenylmethane diisocyanate (MDI), toluene 2,4-diisocyanate (TDI), 3,3′-dimethyl-4,4′-biphenylene diisocyanate (TODD, 1,4-phenylene diisocyanate (PPDI), naphthylene 1,5-diisocyanate (NDI) or 4,4-dibenzyl diisocyanate (DBDI) with a respective polyol.

17. A press jacket for a press roller of a shoe press for dewatering a fibrous paper, cardboard, tissue or pulp material web or a transport band for a machine for producing or treating a fibrous paper, cardboard or tissue material web, the press jacket or the transport band comprising:
at least one layer containing polyurethane, said at least one layer having a polyurethane matrix with a prepolymer being a reaction product of a polyisocyanate with a mixture of at least two different polyols.

18. The press jacket according to claim 17, wherein said at least two polyols have a mixing ratio of from 95/5 to 5/95.

19. The press jacket according to claim 17, wherein said at least two polyols have a mixing ratio of from 75/25 to 50/50.

20. The press jacket according to claim 17, wherein said at least two polyols have a mixing ratio of 50/50.

21. The press jacket according to claim 17, wherein said prepolymer is a reaction product of 4,4′-diphenylmethane diisocyanate (MDI), toluene 2,4-diisocyanate (TDI), 3,3′-dimethyl-4,4′-biphenylene diisocyanate (TODD, 1,4-phenylene diisocyanate (PPDI), naphthylene 1,5-diisocyanate (NDI) or 4,4-dibenzyl diisocyanate (DBDI) with a the mixture of said at least two polyols.

22. A press jacket for a press roller of a shoe press for dewatering a fibrous paper, cardboard, tissue or pulp material web or a transport band for a machine for producing or treating a fibrous paper, cardboard or tissue material web, the press jacket or the transport band comprising:
at least one layer containing polyurethane, said at least one layer having a polyurethane matrix with a prepolymer, and said prepolymer being a reaction product of a polyisocyanate or 4,4′-diphenylmethane diisocyanate (MDI), toluene 2,4-diisocyanate (TDI), 3,3′-dimethyl-4,4′-biphenylene diisocyanate (TODD, 1,4-phenylene diisocyanate (PPDI), naphthylene 1,5-diisocyanate (NDI) or 4,4-dibenzyl diisocyanate (DBDI) or with a polyether polycarbonate polyol, containing polyether groups and carbonate groups.

23. The press jacket according to claim 22, wherein said polyols are selected from: polyester polyol or polycaprolactone polyol, polyether polyol, polypropylene glycol (PPG), polyethylene glycol (PEG) or polyhexamethylene ether glycol, polycarbonate polyol, polyether carbonate polyol, polybutadiene polyol, perfluoropolyether polyol, silicone polyol or silicone diol.

24. The press jacket according to claim 22, wherein said polyether polyol is polytetramethylene ether glycol (PTMEG).

25. The press jacket according to claim 22, which further comprises at least one of:
a crosslinker selected from ethylene glycol, diethylene glycol, propylene glycol, dipolypropylene glycol, polypropylene glycol, polybutylene glycol, 1,4-butanediol, 1,3-propanediol, 1,5-pentanediol, 1,6-hexanediol, polyethylene glycol, dihydroxymethylpropionic acid (DHPA), hydroquinone bis (2-hydroxyethyl) ether (HQEE), hydroxyphenyl ether resorcinol (HER), trimethylolpropane (TMP), hydrazine, ethylenediamine, diethylenetoluenediamine (DEDTA), diethylmethylbenzenediamine (DETDA), methylene-bis-orthochloroaniline (MOCA), dimethylthiotoluenediamine (DMTDA), trimethylene glycol di(p-aminobenzoate) (TMAB), 4,4′-methylene-bis-(3-chloro-2,6-diethylaniline) (MCDEA), 4,4′-methylene-bis-(2,6 -diethylaniline) (MDEA), triisopropanolamine (TIPA), bis-(4-aminocyclohexyl)-methane (PACM), or
a crosslinker formed in part or wholly of the polyols or containing at least one of the polyols with which the prepolymer is prepared.

26. The press jacket according to claim 23, wherein said polyols have a molecular weight of from 1000 to 3000 g/mol.

27. The press jacket according to claim 25, wherein said polyols have a molecular weight of from 1000 to 3000 g/mol.

28. The press jacket according to claim 13, which further comprises a plurality of press jacket layers including an outermost layer, at least said outermost layer having said prepolymer mixture.

29. The press jacket according to claim 17, which further comprises a plurality of press jacket layers including an outermost layer, at least said outermost layer having said prepolymer mixture.

30. The press jacket according to claim 22, which further comprises a plurality of press jacket layers including an outermost layer, at least said outermost layer having said prepolymer mixture.

31. The press jacket according to claim 13, wherein said prepolymer mixture is provided at least in regions.

32. The press jacket according to claim 17, wherein said prepolymer mixture is provided at least in regions.

33. The press jacket according to claim 22, wherein said prepolymer mixture is provided at least in regions.

34. The press jacket according to claim 28, wherein said prepolymer mixture is provided in edge regions of said outermost layer.

35. The press jacket according to claim 29, wherein said prepolymer mixture is provided in edge regions of said outermost layer.

36. The press jacket according to claim 30, wherein said prepolymer mixture is provided in edge regions of said outermost layer.
